(19) United States
(12) Patent Application Publication
(10) Pub. No.: US 2009/0086077 A1
(43) Pub. Date: Apr. 2, 2009

(54) SOLID-STATE IMAGE CAPTURE APPARATUS AND IMAGE CAPTURE APPARATUS

(75) Inventors: Takamasa Wada, Kanagawa (JP); Hiroki Ui, Tokyo (JP); Noriya Maeda, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: SONY CORPORATION, Tokyo (JP)

(21) Appl. No.: 12/235,667

(22) Filed: Sep. 23, 2008

(30) Foreign Application Priority Data
Sep. 28, 2007 (JP) 2007-256789

(51) Int. Cl. H04N 5/335

(52) U.S. Cl. 348/308; 348/E05.091

(57) ABSTRACT

A solid-state image capture apparatus includes a pixel array section with a plurality of pixels arranged in two-dimensional directions, each having a photoelectric conversion section, and pixel drive control section for performing pixel signal readout by sequentially scanning the pixel array section either in a row direction or in a column direction, and driving and controlling individual pixels of the pixel array section through a level shifter circuit. The pixel drive control means includes thinning-out readout control means for performing pixel signal readout, reset control means for resetting either a non-readout pixel row or a non-readout pixel column not being selected by the thinning-out readout control means and gate means for causing the pixel drive control means to perform driving control, whereby current concurrently flowing into the level shifter circuit during the thinning-out readout driving, may be avoided and large current caused by the level shifter circuit may be suppressed.

### BACKGROUND OF THE INVENTION

1. Field of the Invention

The present invention relates to various types of solid-state image capture apparatuses, such as CMOS image sensors, and image capture apparatuses. In particular, the present invention relates to solid-state image capture apparatuses and image capture apparatuses, each having a thinning-out readout function.

2. Description of Related Art

In recent years, development of solid-state image capture apparatuses typically represented by CMOS image sensors has been activated and the apparatuses are used in various types of camera apparatuses, mobile phones, and the like.

The CMOS image sensors are provided with an image capture region in which a plurality of pixels including photodiodes are arranged in two-dimensional directions, and a peripheral circuit region formed outside of the image capture region, both regions being disposed on an identical semiconductor substrate.

Each pixel of the image capture region has various types of pixel transistors such as a readout transistor (a transfer gate) to read out the signal charge of the photodiode onto a FD (a floating diffusion), an amplifier transistor to generate a pixel signal corresponding to the potential of the FD, a selection transistor to select a pixel for outputting the pixel signal, and a reset transistor to reset the FD. The signal charge detected by the photodiode of each pixel is converted to a pixel signal and outputted through a signal line arranged per pixel column by using the drive of each pixel transistor.

The peripheral circuit region is provided with a drive control circuit that controls pixel signal readout by supplying various types of control pulses to a pixel array section, a signal processing circuit that performs various types of signal processings to the readout pixel signal, and a power source control circuit to generate a drive power source.

Laminate films such as an insulating film, a drive electrode film for a transistor, a wiring film and a light blocking film are formed successively on the semiconductor substrate. Further, a color filter, a micro lens and the like are formed through a planarized film or the like.

In the CMOS image sensor thus configured, by using the drives of the respective pixel transistors, the signal charges accumulated in the photodiodes of the respective pixels are converted to pixel signals per each pixel, and then the signal is outputted per pixel column basis and transferred to the subsequent signal processing circuit, and the signal is subjected to noise elimination and signal processings to be outputted.

FIG. 8 is a block diagram showing a configuration example of a CMOS image sensor of the related art.

The shown solid-state image capture apparatus according to present embodiment is an example of XY address type CMOS image sensors of column parallel readout mode configured to simultaneously read out a row of pixel signals.

As shown in FIG. 8, the CMOS image sensor includes a pixel array section 2 in which a plurality of pixels each having a photoelectric conversion sections are arranged in two-dimensional directions, a vertical scan circuit 3 to vertically scan row by row the pixel array section 2, a column CDS circuit 4 that performs CDS processing and other signal processing by capturing column by column the individual pixel signals of the pixel array section 2, a horizontal scan circuit 5 to horizontally scan the column CDS circuit 4, an output circuit 6 that outputs image signals by applying a further necessary signal processing to the pixel signals transferred from the column CDS circuit 4, and a timing generating circuit 7 to synchronize the operation timings of the respective components.

The pixel array section 2 receives a color component light corresponding to the spectral characteristics of a color filter arranged above the pixel array section 2, and generates a pixel signal in accordance with the amount of light.

The vertical scan circuit 3 also controls image capture operation and pixel signal readout operation by controlling the individual pixel circuits of the pixel array section 2, based on various types of pulse signals after being subjected to level adjustment by a level shifter 8.

Each pixel is constituted of one photoelectric conversion section (a photodiode) and, for example, four MOS transistors. The signal charge detected by the photodiode is transferred from the readout transistor to the FD (floating diffusion), and the potential of the FD is detected and amplified to by the amplifier transistor to convert it to a pixel signal. Based on the operation of the selection transistor, the output pixel signal of the amplifier transistor is outputted to a vertical signal line 9 at predetermined output timing. The potential of the FD is reset to a power source potential by the reset transistor at predetermined reset timing.

In the CMOS image sensor, interless multi-row addition readout mode of a column CDS mode is employed and, besides pixel readout and reset, only the pixel reset is carried out for the necessary row so as to avoid variations in the accumulation time of the charge per row of a pixel and suppress image flicker, whereby accumulation time of pixels in all rows are unified (see for example, Japanese Unexamined Patent Application Publication No. JP 2005-191814, Patent Document 1).

Further, there has been proposed one adapted to obtain high quality images free from afterimage, in which in order to eliminate afterimage and blooming, residual charge is eliminated by turning on both a transfer gate and a reset gate after reading out the charge subjected to photoelectric conversion by a photodiode (for example, refer to Japanese Unexamined Patent Application Publication No. JP 2000-209508, Patent Document 2).

### SUMMARY OF THE INVENTION

However, the former of the related art technologies disclosed in Patent Document 1 and Patent Document 2 suffer from the following problem. That is, the pixels normally not read out when the CMOS image sensor performs thinning-out readout are required to be in their reset states all the time in order to suppress the influence of blooming. At the transition from normal drive state to thinning-out readout drive, non-readout pixels (non-readout rows) are concurrently transited to their reset states. As a result, the current concurrently flows into the level shifter circuit, causing, for example, malfunction due to latch-up.

Although the latter is not intended for specifying the interless mode, similarly to the former, there is a risk that excessive current flows into a booster buffer when the transfer gates and the rest gates of all the pixels connected to the selected row during a rest period are concurrently turned on, whereby malfunction of an element may be caused.

The above-described example further suffers from the wiring problem in which the power source line is required to be thick against the excessive current.

Accordingly, it is desirable to provide a solid-state image capture apparatus and an image capture apparatus which are capable of avoiding current concurrently flowing into a level shifter circuit arranged in a scan circuit during thinning-out readout driving, and capable of preventing malfunction or the like.

The solid-state image capture apparatus of an embodiment of the present invention includes a pixel array section and pixel drive control means. The pixel array section is provided with a plurality of pixels arranged in two-dimensional directions, each having a photoelectric conversion section. The pixel drive control means performs pixel signal readout by sequentially scanning the pixel array section either in row direction or in column direction, and driving and controlling individual pixels of the pixel array section through a level shifter circuit. The pixel drive control means includes thinning-out readout control means, reset control means and gate means. The thinning-out readout control means performs pixel signal readout by selecting pixels of the pixel array section on either a per-row or per-column basis. The reset control means resets either a non-readout pixel row or a non-readout pixel column not being selected by the thinning-out readout control means. The gate means causes the pixel drive control means to perform driving control without through the level shifter circuit during thinning-out readout driving by the thinning-out readout control means. The solid-state image capture apparatus is characterized in that current concurrently flowing into the level shifter circuit during the thinning-out readout driving is avoided, thereby suppressing large current caused by the level shifter circuit.

The image capture apparatus of the present invention has an image capture section using a solid-state image capture apparatus, a controller to control the image capture section and an operation section to operate the image capture section. The solid-state image capture apparatus includes a pixel array section and pixel drive control means. The pixel array section is provided with a plurality of pixels arranged in two-dimensional directions, each having a photoelectric conversion section. The pixel drive control means performs pixel signal readout by sequentially scanning the pixel array section either in row direction or in column direction, and driving and controlling individual pixels of the pixel array section through a level shifter circuit. The pixel drive control means includes thinning-out readout control means, reset control means and gate means. The thinning-out readout control means performs pixel signal readout by selecting pixels of the pixel array section on either a per-row or per-column basis. The reset control means resets either a non-readout pixel row or a non-readout pixel column not being selected by the thinning-out readout control means. The gate means causes the pixel drive control means to perform driving control not through the level shifter circuit during thinning-out readout driving by the thinning-out readout control means. The apparatus of the present invention is characterized in that current concurrently flowing into the level shifter circuit during the thinning-out readout driving is avoided, thereby suppressing large current caused by the level shifter circuit.

According to the solid-state image capture apparatus and the image capture apparatus, owing to the gate means causing the pixel drive control means to perform driving control without through the level shifter circuit during thinning-out readout driving, it is possible to avoid current concurrently flowing into the level shifter circuit during the thinning-out readout driving. This enables suppression of large current caused by the level shifter circuit and prevention of malfunction or the like caused by the level shifter circuit.

### BRIEF DESCRIPTION OF THE DRAWINGS

FIG. 1 is a block diagram showing a configuration example of a CMOS image sensor according to an embodiment of the present invention;

FIG. 2 is a circuit diagram showing a configuration example of a vertical scan circuit of the CMOS image sensor shown in FIG. 1;

FIG. 3 is a circuit diagram showing a configuration example (embodiment 1) of a drive circuit provided in the CMOS image sensor shown in FIG. 1;

FIG. 4 is a circuit diagram showing configuration example (embodiment 2) of the drive circuit included in the CMOS image sensor shown in FIG. 1;

FIG. 5 is a circuit diagram showing configuration example (embodiment 3) of the drive circuit included in the CMOS image sensor shown in FIG. 1;

FIG. 6 is a circuit diagram showing configuration example (embodiment 4) of the drive circuit included in the CMOS image sensor shown in FIG. 1;

FIG. 7 is a circuit diagram showing configuration example (embodiment 5) of the drive circuit included in the CMOS image sensor shown in FIG. 1;

FIG. 8 is a block diagram showing a configuration example of a CMOS image sensor of the related art; and

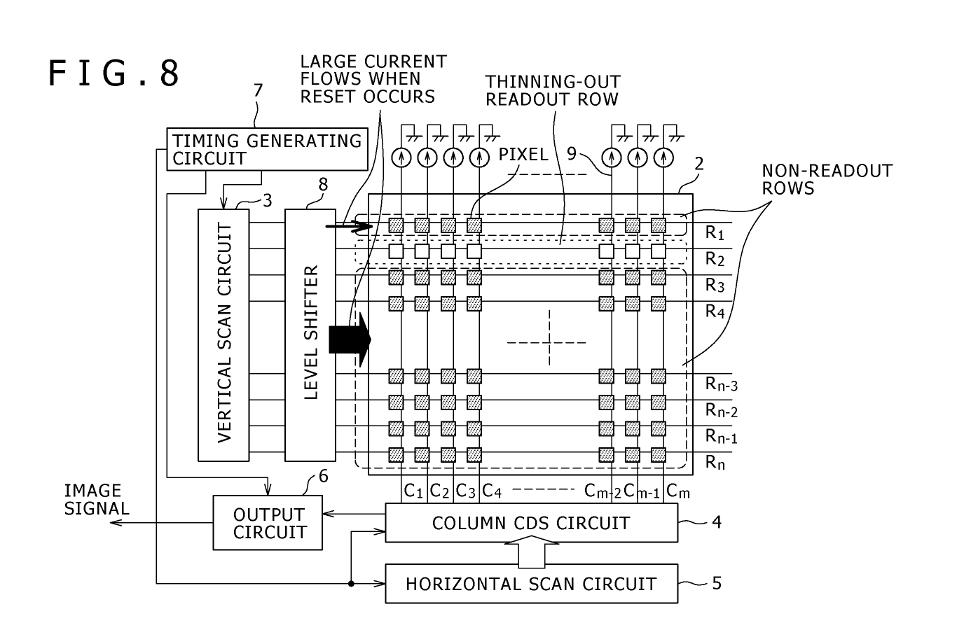

FIG. 9 is a block diagram showing a configuration example of a camera apparatus according to other embodiment of the present invention.

### DETAILED DESCRIPTION OF THE EMBODIMENTS

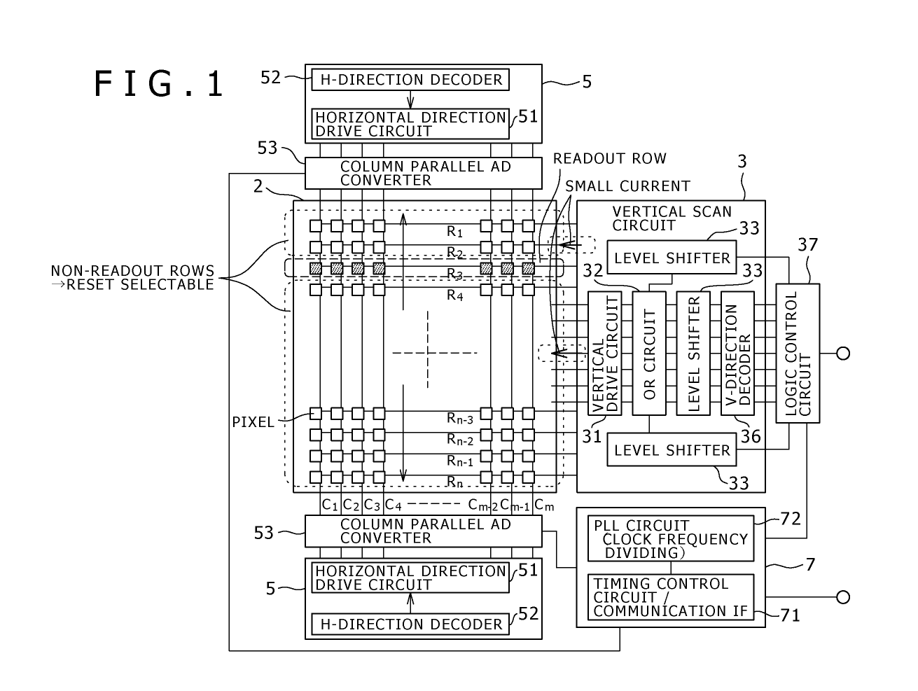

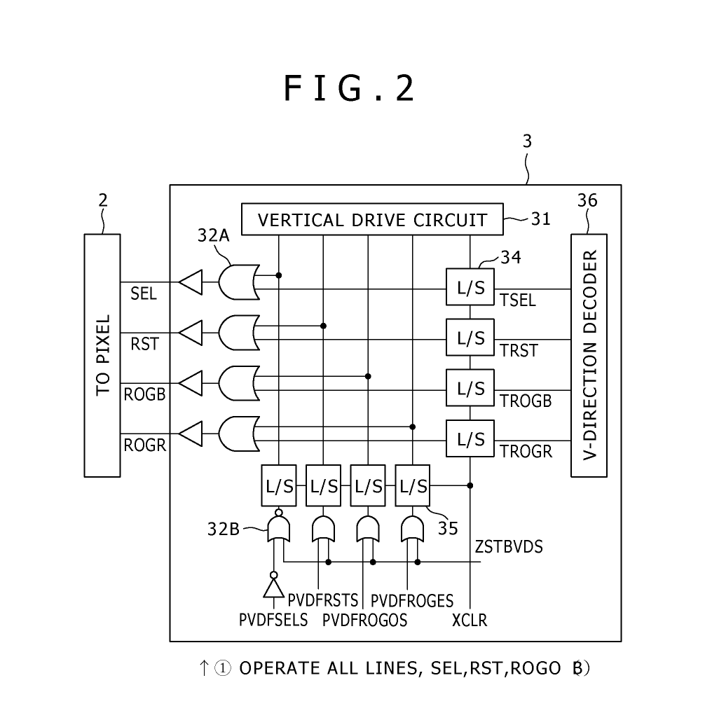

FIG. 1 shows a block diagram showing an overall configuration example of a solid-state image capture apparatus according to an embodiment of the present invention. FIG. 2 is a block diagram showing a configuration example of a vertical scan circuit of the CMOS image sensor shown in FIG. 1.

As shown in the drawings, the CMOS image sensor of the present embodiment has a pixel array section 2, a vertical scan circuit 3, a column CDS circuit 4, horizontal scan circuits 5, an output circuit 6 and a timing generating circuit 7. The vertical scan circuit 3 includes a vertical drive circuit 31, an OR circuit 32, level shifters 33 and a V-direction decoder 36, and a logic control circuit 37 to control the components is annexed to the vertical scan circuit 3.

The present embodiment aims to avoid current concurrently flowing into the level shifters during thinning-out readout driving, by providing the OR circuit 32 and the three level shifters 33.

The horizontal scan circuits 5 are arranged on the upper and lower sides of the pixel array section 2, respectively, each having a horizontal direction drive circuit 51 and an H-direction decoder 52, to which pixel signals digitalized by a column parallel AD converter 53 at the preceding stage are inputted and processed.

The timing generating circuit 7 has a timing control circuit/communication IF 71 to control timings by inputting the instruction data and the like from the outside, and a PLL circuit 72 to perform frequency division of clock.

The vertical drive circuit 31 shown in FIG. 2 has the configuration in which reset operation is applied to all the lines of a row selection gate SEL, a reset gate RST and a readout gate ROG (B, R). Each output of the V-direction decoder 36 is connected through a level shifter (L/S) 34 to one input of an OR circuit 32A for controlling each gate, and an output signal line from the vertical drive circuit 31 is directly connected to the other input. An output signal of an OR circuit 32B is also connected through a level shifter (L/S) 35 to the other input of the OR circuit 32A.

In the circuit, when thinning-out readout is performed, the pixels of a row to be thinned out are reset at all times. Therefore, a PVDFRSTS signal, a PVDFROGES signal and a PVDFROGOS signal shown in FIG. 2 are operated to concurrently reset the pixels of the row to be thinned out. In FIG. 2, description is made for one pixel, but when a plurality of pixels are adopted, connection is made to the OR circuits of each rows which are desired to operate concurrently.

In the rows whose pixels are reset, while it is surely necessary that the PVDFROGES and the PVDFROGOS are connected and operated, the signal line of the PVDFRSTS may be operated or not be operated by option. The operations of each signal lines may be simultaneously or non-simultaneously.

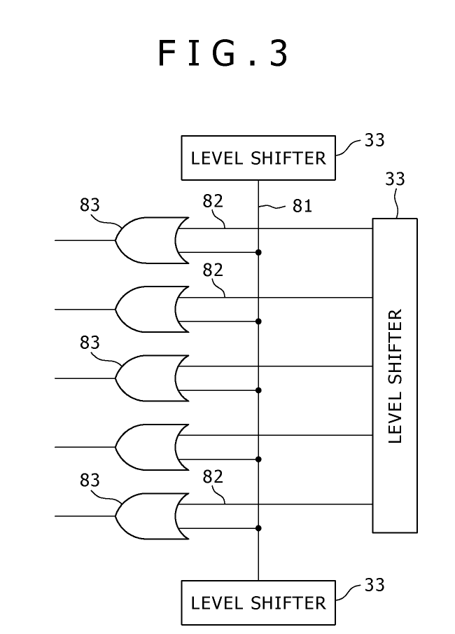

FIG. 3 is a circuit diagram showing a configuration example (Example 1) of a drive circuit enabling per-column reset control in the present embodiment.

The pixel reset operation can be applied to an entire column of the selected columns by using the circuit configuration in which pixel signal lines 81 in a column direction and row selection lines 82 are inputted to OR circuits 83 to take the logical sum, as shown in the figure. In this case, the arrangement of the selector circuits (not shown) in the upper and lower directions enables the reset operation in a column direction corresponding to the vertical thinning-out readout.

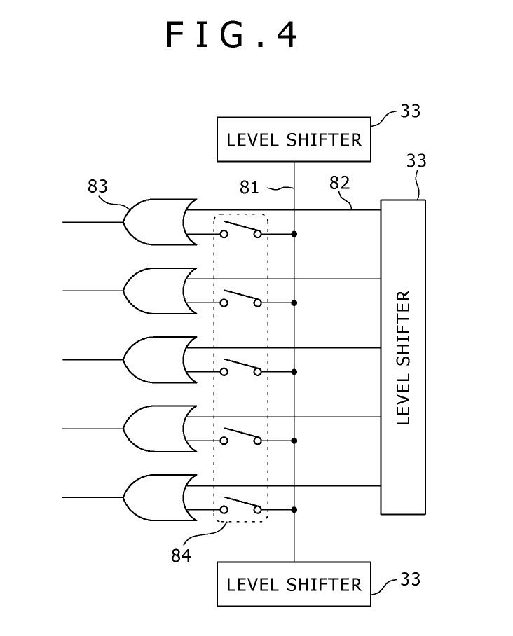

FIG. 4 is a circuit diagram showing a configuration example (Example 2) of a drive circuit enabling per-pixel reset control in the present embodiment.

That is, the example enables the per-pixel reset control by arranging column selection switches 84 on the respective column connecting lines of the OR circuits 83 shown in FIG. 3, respectively. Compared with Example 1 of FIG. 3, Example 2 of FIG. 4 can achieve more flexible reset control owing to the individual reset operation with respect to pixels specified by row and column.

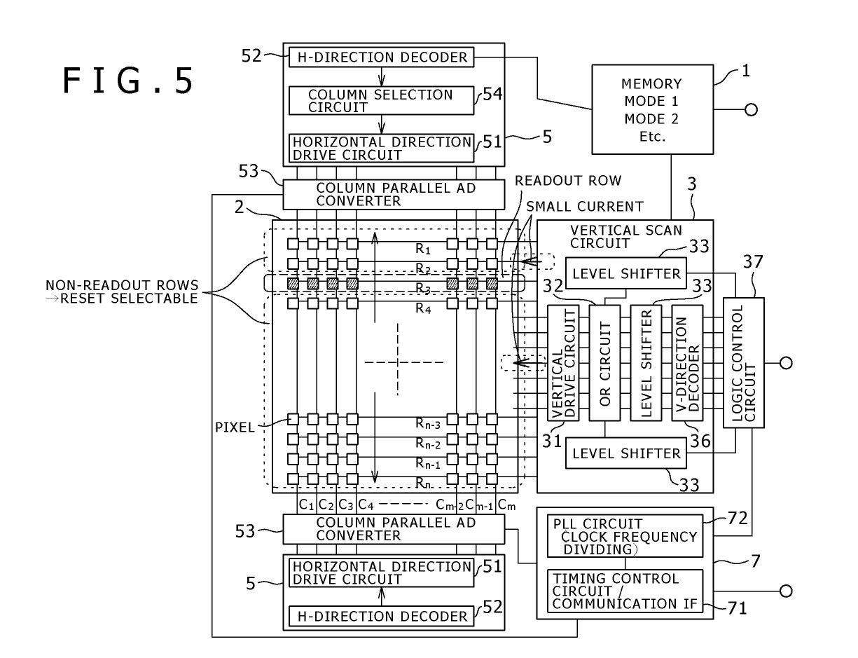

Although details are omitted here, a programmed reset operation becomes possible by further using a memory 1 and the like, as shown in FIG. 5 (Example 3). This produces the following advantages. That is, a pixel region corresponding to a fast moving object in the center of the screen may be subjected to a fast reset operation, and the surrounding video other than that object may be subjected to such a control as to delay the reset time. In other words, it is capable of producing the shooting effect that only a specific region including a moving object is clearly captured clearly and its surrounding video is defocused. In FIG. 5, the memory 1 contains programmed data such as mode 1 and mode 2, which can be suitably selected and read out for use in the image capture processes by a user. The configuration of FIG. 5 makes possible per-pixel selection by arranging column selection circuits 54 in the horizontal scan circuits 5, respectively.

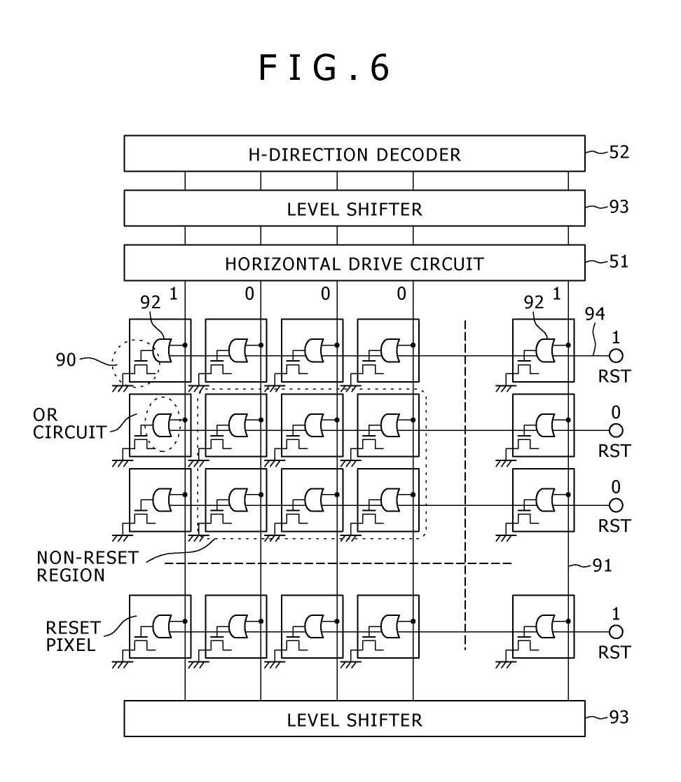

FIG. 6 is a circuit diagram showing a configuration example (Example 4) of a drive circuit to perform per-pixel selection by providing OR circuits within pixels in the present embodiment.

As shown in the figure, in the example, OR circuits 92 for resetting reset transistors 90 are provided in each pixel. In the figure, vertical signal lines 91 are control signal lines for inputting the control signals supplied from a logic control circuit 37 shown in FIG. 2 to a first input end of each of the OR circuits 92, and level shifters 93 are arranged are arranged in an upper and lower directions to suppress a voltage drop due to wire resistance. Each of lateral control signal lines 94 connected to laterally arranged level shifters (not shown) is inputted to a second input end of the OR circuits 92, whereby OR operation with the control signal inputted to the first input end is performed. In this example, reset signals RST are controlled in accordance with a row reset address prespecified within the logic control circuit 37 in advance.

Also in the example, by using the memory 1 shown in FIG. 5, it is capable of attaining the state that a partial region of an effective pixel region is not reset but the other region is reset in accordance with the prerecorded row-column address. For example, in the configuration that the outputs of the OR circuits 92 are connected to the gates of the reset transistors 90 in a pixel, it is capable of attaining the state that a partial pixel region is not reset but the other pixel region is reset by performing OR operation in pixels by using the control signals in a column direction and the reset signals in a row direction, as shown in the figure.

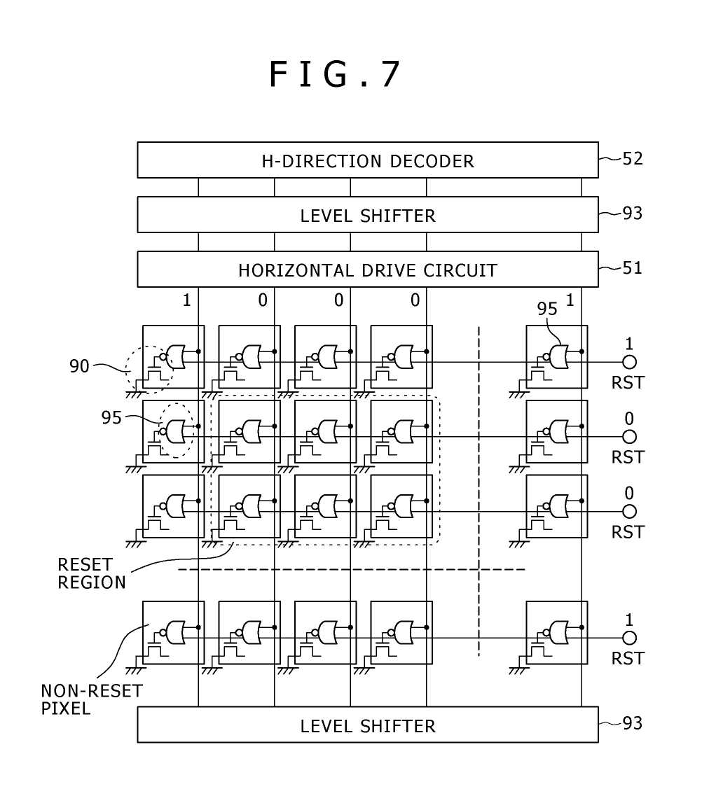

FIG. 7 is a circuit diagram showing a configuration example (Example 5) of a drive circuit to perform per-pixel selection by providing NOR circuits within pixels in the present embodiment.

As shown in the figure, in the example, NOR circuits 95 for resetting reset transistors 90 are provided in individual pixels, respectively. For example, in the configuration that the outputs of the NOR circuits 95 are connected to the gates of the reset transistors 90 in pixels, it is capable of attaining the state that a partial pixel region is not reset but the other pixel region is reset (the reset region is the reverse of that in FIG. 6) by implementing an NOR operation within pixels by using the control signals in column direction and the reset signals in row direction, as shown in the figure.

The foregoing examples according to the present invention may also produce the following effects.
(1) No latch-up occurs.
(2) Malfunction is avoidable.
(3) Flexible reset control may be performed to non-readout rows.
(4) Flexible reset control may be performed to non-readout columns.
(5) Programmable reset becomes possible.
(6) Not so large consumption current is required (for example, it is easy to set power save mode or the like).
(7) There is no need to thick the power source line.

Although description is made for certain embodiments of the solid-state image capture apparatus in the present invention, further various modifications may be made.

For example, though description is made in the above-describe embodiment about the configuration that the four transistors are provided in a pixel, the present invention may be widely applicable to various types of other solid-state image capture apparatuses, such as CMOS image sensors and CCD image sensors having other pixel configuration.

The solid-state image capture apparatuses are not limited to ones in which an image sensor or the like are arranged on a single chip. The apparatuses may be modules collectively packaging an image capture section, a signal processing section and an optical system. Alternatively, these may be apparatuses used in camera systems and mobile phones. Noted, in embodiments of the present invention, the configuration that has an image sensor function as a single unit is referred to as the solid-state image capture apparatus, and the configuration that the solid-state image capture apparatus and other elements (the control circuit, the operation section and the display section, as well as a data accumulation function, a communication function and the like) are integrated together is referred to as the image capture apparatus.

The following is a specific example of the image capture apparatus to which the present invention is applied.

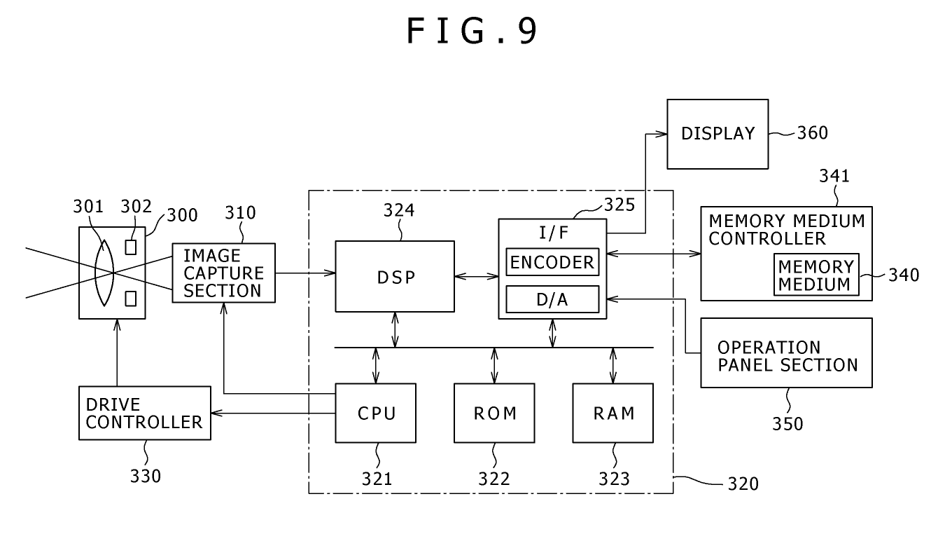

FIG. 9 is a block diagram showing a configuration example of a camera apparatus using the image sensor of the foregoing embodiment.

In FIG. 9, an image capture section 310, which is for shooting an object by using the image sensor shown in FIG. 1 or FIG. 2, outputs image capture signals to a system control section 320 mounted on the main substrate.

That is, the image capture section 310 generates and outputs digital image capture signals by applying AGC (automatic gain control), OB (optical black) clamp, CDS (correlative dual sampling) and A/D conversion processings to the above-described output signals of the image sensor.

In this embodiment, the example in which the image capture section 310 converts image capture signals to digital signals and then output them to the system control section 320 is shown. Alternatively, a configuration in which analog image capture signals may be sent from the image capture section 310 to the system control section 320, and the system control section 320 may convert the signals into digital signals may be employed.

Various methods of specific control operations and signal processings within the image capture section 310 have been provided, and therefore, not to mention, no particular limitations are imposed on the image capture apparatus of the present invention.

An image capture optical system 300 includes a zoom lens 301 and an aperture mechanism 302 arranged in a lens barrel, and forms an object image on a light receiving section of the image sensor. Under the control of a drive controller 330 based on the instruction of the system control section 320, the respective components are mechanically driven to perform control, such as auto-focus or the like.

The system control section 320 includes a CPU 321, a ROM 322, a RAM 323, a DSP 324, an external interface 325 and the like.

The CPU 321 controls the entire system by sending instructions to the respective sections of the camera apparatus by use of the ROM 322 and the RAM 323.

The DSP 324 generates video signals (e.g. YUV signals) of a still image or a moving image in a predetermined format by applying various signal processings to the image capture signals from the image capture section 310.

The external interface 325 is provided with various types of encoders and a D/A converter, and exchanges various types of control signals and data with external elements connected to the system control section 320 (in this example, a display 360, a memory medium 340 and an operation panel section 350).

The display 360 is a small display device such as a liquid crystal panel assembled into the camera apparatus, and displays captured images. In addition to the small display device assembled in the camera apparatus, not to mention, a configuration in which image data may be transferred to an external large display device and displayed thereon, may be adopted.

The memory medium 340 can suitably store the captured image in various types of memory cards et al, and can exchange the memory medium with, for example, the memory medium controller 341. As the memory medium 340, disk medium using magnetism and light may also be used besides the various types of memory cards.

The operation panel section 350 is provided with input keys through which the user issues various types of instruction when performing image capture operations with the camera apparatus. The CPU 321 monitors the input signals from the operation panel section 350 and executes various types of operation controls based on the input contents.

By applying the solid-state image capture apparatus of the present invention to the camera apparatus, a high-performance image capture apparatus having an effective window cutout function can be provided. In the foregoing configuration, the combination of a unit device and a unit module which are constituent elements of the system, and scale of the set can be selected, as appropriate, based on the circumstances of product commercialization and the like. That is, the image capture apparatus of the present invention includes a wide variety of modifications.

In the solid-state image capture apparatus and the image capture apparatus according to embodiments of the present invention, a target of shooting (the object) is not limited to general video, such as people and sceneries etc. These apparatuses are also applicable to the purposes of shooting special micro image patterns, such as counterfeit bill detectors and fingerprint detectors.

As apparatus configuration of this case, the apparatus is arranged to be different from the general camera apparatus as shown in FIG. 9, but to have a special image capture optical system and a signal processing system including pattern analysis. Also in this case, the effect of the present invention can be sufficiently exhibited to achieve accurate image detection.

In the case of configuring remote systems, such as remote medical care systems, security monitors and personal authentication, the apparatus configuration including a communication module connected to a network as described above may be also adopted, thereby permitting a wide range of applications thereof.

It should be understood by those skilled in the art that various modifications, combinations, sub-combinations and alterations may occur depending on design requirements and other factors insofar as they are within the scope of the appended claims or the equivalents thereof.

The present document contains subject matter related to Japanese Patent Application No. 2007-256768 filed in the Japanese Patent Office on Sep. 28, 2007, the entire content of which being incorporated herein by reference.

What is claimed is:

1. A solid-state image capture apparatus comprising:
a pixel array section with a plurality of pixels arranged in two-dimensional directions, each pixel having a photoelectric conversion section; and
pixel drive control means for performing pixel signal readout by sequentially scanning the pixel array section either in a row direction or in a column direction, and driving and controlling individual pixels of the pixel array section through a level shifter circuit, wherein;
the pixel drive control means includes;
thinning-out readout control means for performing pixel signal readout by selecting pixels of the pixel array section on either a per-row or per-column basis;
reset control means for resetting either a non-readout pixel row or a non-readout pixel column not being selected by the thinning-out readout control means; and
gate means for causing the pixel drive control means to perform driving control not through the level shifter circuit during thinning-out readout driving by the thinning-out readout control means, and whereby
current concurrently flowing into the level shifter circuit during the thinning-out readout driving, may be avoided and large current caused by the level shifter circuit may be suppressed.

2. The solid-state image capture apparatus according to claim 1, wherein;
in a non-readout row reset operation, the reset control means enables a per-row reset operation to be executed only for a selected row, to be executed simultaneously for a plurality of selected rows, to be executed for a selected row at certain time intervals, or to be executed for selected rows based on a predetermined order.

3. The solid-state image capture apparatus according to claim 1, wherein;
the pixel array section and the pixel drive control means are provided on an identical semiconductor chip.

4. A solid-state image capture apparatus comprising:
a pixel array section with a plurality of pixels arranged in two-dimensional directions, each pixel having a photoelectric conversion section; and
pixel drive control means for performing pixel signal readout by sequentially scanning the pixel array section either in a row direction or in a column direction, and driving and controlling individual pixels of the pixel array section through a level shifter circuit, wherein;
the pixel drive control means includes;
thinning-out readout control means for performing pixel signal readout by selecting pixels of the pixel array section on a per-pixel basis;
reset control means for resetting a non-readout pixel not being selected by the thinning-out readout control means; and
gate means for causing the pixel drive control means to perform driving control not through the level shifter circuit during thinning-out readout driving by the thinning-out readout control means, whereby
current concurrently flowing into the level shifter circuit during the thinning-out readout driving may be avoided, and large current caused by the level shifter circuit may be suppressed.

5. The solid-state image capture apparatus according to claim 4, wherein;
a pixel reset operation is not performed on a prespecified partial region within an effective pixel region but the pixel reset operation is performed on the region other than the prespecified region by implementing a logical OR operation of a column address output and a row reset signal under an arrangement that OR circuits are arranged in individual pixels of the pixel array section, a row reset line is connected to one input end of each of the OR circuits, a column address selection line is connected to the other input end and an output end of each of the OR circuits is connected to a gate section of each of reset transistors provided in the individual pixels.

6. The solid-state image capture apparatus according to claim 4, wherein;
a pixel reset operation is performed on a prespecified partial region within an effective pixel region and the pixel reset operation is not performed on the region other than the prespecified region by implementing a NOR operation of a column address output and a row reset signal under an arrangement that NOR circuits are arranged on individual pixels of the pixel array section, a row reset line is connected to one input end of each of the NOR circuits, a column address selection line is connected to the other input end and an output end of each of the NOR circuits is connected to a gate section of each of reset transistors provided in the individual pixels.

7. The solid-state image capture apparatus according to claim 4, further comprising:
a memory section storing several modes preprogrammed so as to have a specified column address and a specified row reset address, wherein;
the driving control of the thinning-out readout is performed based on data stored in the memory section.

8. The solid-state image capture apparatus according to claim 4, wherein;
the pixel array section and the pixel drive control means are mounted on an identical semiconductor chip.

9. An image capture apparatus comprising:
an image capture section using a solid-state image capture apparatus;
a controller to control the image capture section; and
an operation section to operate the image capture section, wherein the solid-state image capture apparatus includes;
a pixel array section with a plurality of pixels arranged in two-dimensional directions, each pixel having a photoelectric conversion section; and
pixel drive control means for performing pixel signal readout by sequentially scanning the pixel array section either in a row direction or in a column direction, and driving and controlling individual pixels of the pixel array section through a level shifter circuit, wherein;
the pixel drive control means includes;
thinning-out readout control means for performing pixel signal readout by selecting pixels of the pixel array section on either a per-row or per-column basis;
reset control means for resetting either a non-readout pixel row or a non-readout pixel column not being selected by the thinning-out readout control means; and
gate means for causing the pixel drive control means to perform driving control not through the level shifter circuit during thinning-out readout driving by the thinning-out readout control means, whereby
current concurrently flowing into the level shifter circuit during the thinning-out readout driving may be avoided, and large current caused by the level shifter circuit may be suppressed.

10. The image capture apparatus according to claim 9, wherein in a non-readout row reset operation, the reset control means enables a per-row reset operation to be executed only for a selected row, to be executed simultaneously for a plurality of selected rows, to be executed for a selected row at certain time intervals or to be executed for selected rows based on a predetermined order.

11. The image capture apparatus according to claim 9, wherein;
the pixel array section and the pixel drive control means are mounted on an identical semiconductor chip.

12. An image capture apparatus comprising:
an image capture section using a solid-state image capture apparatus;
a controller to control the image capture section and;
an operation section to operate the image capture section, wherein;
the solid-state image capture apparatus includes;
a pixel array section with a plurality of pixels arranged in two-dimensional directions, each pixel having a photoelectric conversion section; and
pixel drive control means for performing pixel signal readout by sequentially scanning the pixel array section either in a row direction or in a column direction, and driving and controlling individual pixels of the pixel array section through a level shifter circuit, wherein;
the pixel drive control means includes;
thinning-out readout control means for performing pixel signal readout by selecting pixels of the pixel array section on a per-pixel basis;
reset control means for resetting a non-readout pixel not being selected by the thinning-out readout control means; and
gate means for causing the pixel drive control means to perform driving control not through the level shifter circuit during thinning-out readout driving by the thinning-out readout control means, whereby
current concurrently flowing into the level shifter circuit during the thinning-out readout driving may be avoided, and large current caused by the level shifter circuit may be suppressed.

13. The image capture apparatus according to claim 12, wherein;
a pixel reset operation is not performed on a prespecified partial region within an effective pixel region and the pixel reset operation is performed on the region other than the specified region by implementing a OR operation of a column address output and a row reset signal under an arrangement that OR circuits are arranged on individual pixels of the pixel array section, a row reset line is connected to one input end of each of the OR circuits, a column address selection line is connected to the other input end and an output end of each of the OR circuits is connected to a gate section of each of reset transistors provided in the individual pixels.

14. The image capture apparatus according to claim 12, wherein;
a pixel reset operation is performed on a prespecified partial region within an effective pixel region and the pixel reset operation is not performed on the region other than the specified region by implementing a NOR operation of a column address output and a row reset signal under an arrangement that NOR circuits are arranged on individual pixels of the pixel array section, a row reset line is connected to one input end of each of the NOR circuits, a column address selection line is connected to the other input end and an output end of each of the NOR circuits is connected to a gate section of each of reset transistors provided in the individual pixels.

15. The image capture apparatus according to claim 12, further comprising:
a memory section storing several modes preprogrammed so as to have a specified column address and a specified row reset address, wherein;
the driving control of the thinning-out readout is performed based on data stored in the memory section.

16. The image capture apparatus according to claim 12, wherein;
the pixel array section and the pixel drive control means are mounted on an identical semiconductor chip.

17. A solid-state image capture apparatus comprising:
a pixel array section with a plurality of pixels arranged in two-dimensional directions, each pixel having a photoelectric conversion section; and
pixel drive control section for performing pixel signal readout by sequentially scanning the pixel array section either in a row direction or in a column direction, and driving and controlling individual pixels of the pixel array section through a level shifter circuit, wherein;
the pixel drive control means includes;
thinning-out readout control means for performing pixel signal readout by selecting pixels of the pixel array section on either a per-row or per-column basis;
reset control means for resetting either a non-readout pixel row or a non-readout pixel column not being selected by the thinning-out readout control means; and
gate means for causing the pixel drive control means to perform driving control not through the level shifter circuit during thinning-out readout driving by the thinning-out readout control means, and whereby
current concurrently flowing into the level shifter circuit during the thinning-out readout driving, may be avoided and large current caused by the level shifter circuit may be suppressed.
